(19) United States
(12) Patent Application Publication
(10) Pub. No.: US 2025/0165715 A1
(43) Pub. Date: May 22, 2025

(54) COMMENT ANALYSIS SYSTEM AND COMMENT ANALYSIS METHOD

(71) Applicant: Innolux Corporation, Miaoli County (TW)

(72) Inventors: Bang-Chi Lin, Miaoli County (TW); Chao-Hsuan Ko, Miaoli County (TW)

(73) Assignee: Innolux Corporation, Miaoli County (TW)

(21) Appl. No.: 18/921,032

(22) Filed: Oct. 21, 2024

(30) Foreign Application Priority Data
Nov. 21, 2023 (CN) 202311557415.4

(51) Int. Cl. G06F 40/30; G06F 16/951

(52) U.S. Cl. CPC G06F 40/30; G06F 16/951

(57) ABSTRACT

A comment analysis system and a comment analysis method are provided. The comment analysis system includes a crawling module, a text detection module, an analysis module and a determination module. The crawling module is used to search for multiple user comments from the network database and store the user comments into the database. The text detection module includes a font library. The font library has multiple preset word strings. The text detection module is configured to collect at least one of the user comments that includes at least one of the word strings. The analysis module is configured to analyze at least one of the user comments. The determination module is configured to determine whether the word strings have constructive significance in at least one of the user comments based on the analysis result of the at least one of the user comments.

### CROSS-REFERENCE TO RELATED APPLICATION

This application claims the priority benefit of China application serial no. 202311557415.4, filed on Nov. 21, 2023. The entirety of the above-mentioned patent application is hereby incorporated by reference herein and made a part of this specification.

### BACKGROUND

### Technical Field

The disclosure relates to an automated data analysis technology, and in particular relates to a comment analysis system and a comment analysis system and a comment analysis method.

### Description of Related Art

Generally speaking, the comment information provided by users after purchasing a product may allow the product manufacturer or product seller to know not only the evaluation of the user of the product, but also the potential defects of the product. However, as the number of purchasing users increases, the product comment information provided by users also increases exponentially, so it is quite impractical to manually collect relevant information.

### SUMMARY

The disclosure is directed to a comment analysis system and a comment analysis method that may automatically crawl and analyze comment information in a network database.

According to an embodiment of the disclosure, the comment analysis system of the disclosure includes a crawling module, a text detection module, an analysis module, and a determination module. The crawling module is coupled to a network database and configured to search for multiple user comments from the network database and store the user comments into a database. The text detection module is coupled to the crawling module and includes a font library. The font library has multiple preset word strings. The text detection module is configured to collect at least one of the user comments that includes at least one of the word strings. The analysis module is coupled to the text detection module and configured to analyze at least one of the user comments. The determination module is coupled to the analysis module and configured to determine whether the word strings have constructive significance in at least one of the user comments according to an analysis result of the at least one of the user comments.

According to an embodiment of the disclosure, the comment analysis method of the disclosure includes the following operation. Multiple user comments is searched for from the network database and the user comments is stored into the database through the crawling module. At least one of the user comments is collected through the text detection module, in which the text detection module includes a font library, and the font library has multiple preset word strings, the at least one of the user comments includes the at least one of the word strings. Sentiment analysis is performed on the at least one of the user comments through a sentiment analysis module. Whether the word strings have constructive significance in the at least one of the user comments is determined through the determination module according to an analysis result of the at least one of the user comments.

Based on the above, the comment analysis system and the comment analysis method of the disclosure may automatically crawl user comments in a network database, and may automatically analyze user comments to determine whether user comments have constructive significance.

To facilitate a better understanding of the above content, several embodiments accompanying the diagram will be described in detail below.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain principles of the disclosure.

FIG. 1 is a schematic diagram of a comment analysis system according to an embodiment of the disclosure.

FIG. 2 is a schematic diagram of multiple modules according to an embodiment of the disclosure.

FIG. 3 is a flowchart of a comment analysis method according to an embodiment of the disclosure.

FIG. 4 is a flowchart of crawling user comments according to an embodiment of the disclosure.

FIG. 5 is a schematic diagram of crawling user comments according to an embodiment of the disclosure.

FIG. 6 is a schematic diagram of crawling user comments according to another embodiment of the disclosure.

FIG. 7 is a schematic diagram of establishing a sentiment analysis model according to an embodiment of the disclosure.

FIG. 8 is a flowchart of a comment analysis method according to an embodiment of the disclosure.

FIG. 9 is a schematic diagram of establishing a model and a comment analysis method according to an embodiment of the disclosure.

FIG. 10 is a schematic diagram of a statistical control graph according to an embodiment of the disclosure.

### DETAILED DESCRIPTION OF DISCLOSED EMBODIMENTS

References of the exemplary embodiments of the disclosure are to be made in detail. Examples of the exemplary embodiments are illustrated in the drawings. If applicable, the same reference numerals in the drawings and the descriptions indicate the same or similar parts.

Throughout this disclosure and the accompanying claims, certain terms are used to refer to specific elements. It should be understood by those skilled in the art that electronic device manufacturers may refer to the same elements by different names. The disclosure does not intend to distinguish between elements that have the same function but have different names. In the following description and claims, words such as “comprise” and “include” are open-ended terms and should be interpreted as “including, but not limited to . . . ”.

Throughout the entire disclosure (including the accompanying claims), the term “coupling” (or connection) may refer to any direct or indirect connection. For example, if the specification states that a first device is coupled (or connected) to a second device, it should be interpreted to mean that the first device may be directly connected to the second device, or the first device may be indirectly connected to the second device through other devices to be connected or certain connection methods. Throughout the specification of the application (including the accompanying claims), the terms “first,” “second,” and similar terms are used only to name discrete elements, or to distinguish between different embodiments or scopes.

Accordingly, such terms should not be construed as limiting an upper or lower limit on the number of elements and should not be used to limit the order in which elements are arranged. In addition, elements/components/steps using the same reference numbers in the drawings and embodiments are used wherever possible to represent the same or similar parts. In different embodiments, the same reference numbers may be used or the same terminology may be used to refer to related descriptions of elements/components/steps.

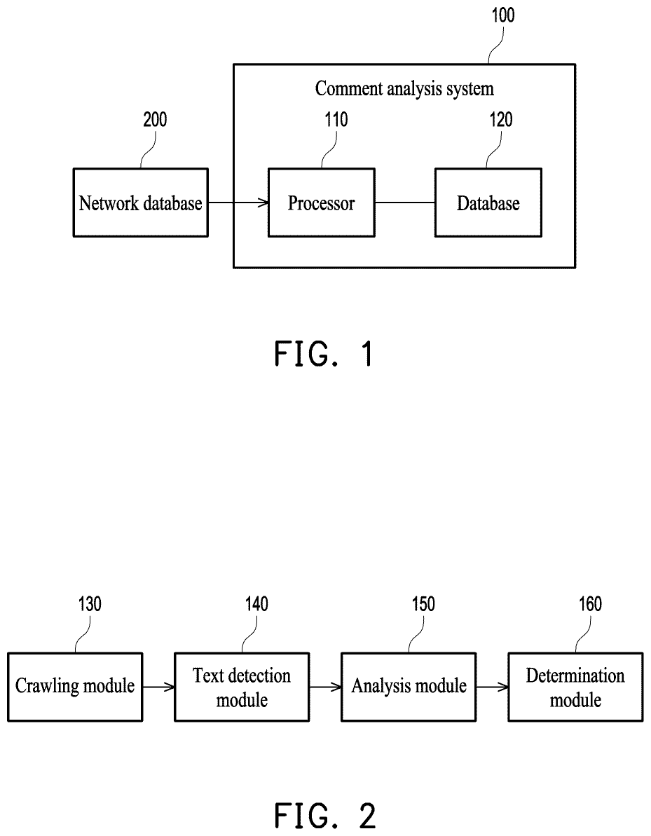

FIG. 1 is a schematic diagram of a comment analysis system according to an embodiment of the disclosure. Referring to FIG. 1, the comment analysis system 100 includes a processor 110 and a database 120. The processor 110 is coupled to the database 120 and coupled to an external network database 200. In this embodiment, the network database 200 may be configured, for example, to implement one or more network platforms and to sell specific products, such as display panels. The number of network database 200 is not limited to one. The network database 200 may store user comments edited on a web page by multiple users at different times regarding their experiences after purchasing a specific product during the sale of a specific product. In this embodiment, the comment analysis system 100 may, for example, be implemented in the form of a cloud server, but the disclosure is not limited thereto. The comment analysis system 100 may automatically and periodically crawl multiple user comments recorded in the network database 200, and may automatically analyze the user comments to determine whether at least one of the user comments has constructive significance.

In this embodiment, the processors 110 may include, for example, a central processing unit (CPU), a graphics processing unit (GPU), or other programmable general-purpose or special-purpose microprocessor, a digital signal processor (DSP), a programmable controller, an application specific integrated circuit (ASIC), a programmable logic device (PLD), or other similar processing devices or a combination of these devices.

In this embodiment, the database 120 includes, for example, any type of fixed or removable random access memory (RAM), read-only memory (ROM), flash memory, hard disk, or other circuits or chips with similar functions, or a combination of these devices, circuits and chips. The database 120 may be configured to store multiple modules, and the modules may be read and executed by the processor 110. The storage device may also be configured to store relevant data and information generated during the comment analysis process, and/or store relevant data required during the comment analysis process. In this embodiment, the comment analysis system 100 may also include a related communication interface to connect to the network database 200 through wired or wireless means. In another embodiment of the disclosure, multiple modules may be built into the processor 110.

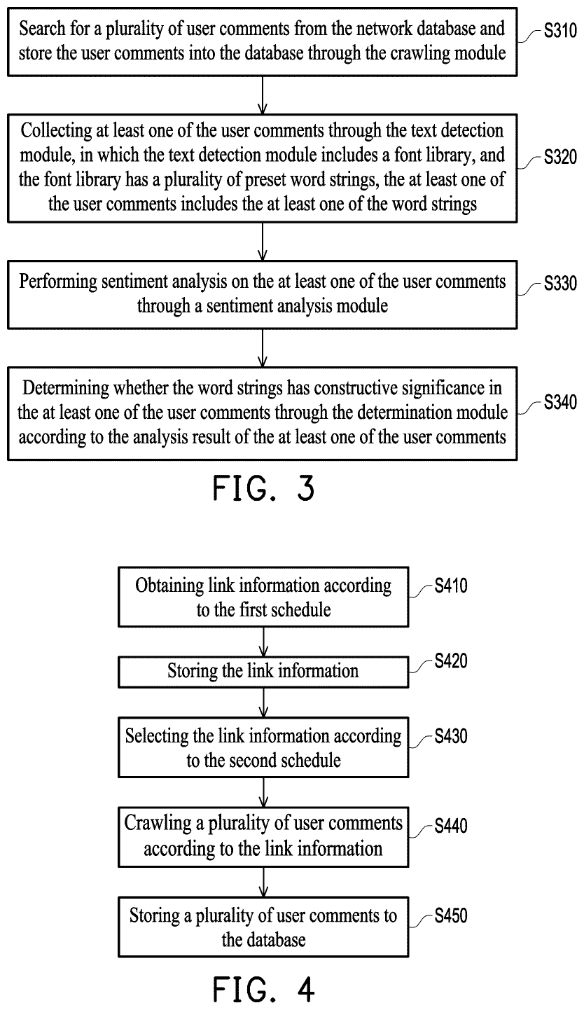

FIG. 2 is a schematic diagram of multiple modules according to an embodiment of the disclosure FIG. 3 is a flowchart of a comment analysis method according to an embodiment of the disclosure. Referring first to FIG. 1 to FIG. 3, the comment analysis system 100 may be pre-established (stored) with a crawling module 130, a text detection module 140, an analysis module 150, and a determination module 160. In this embodiment, the processor 110 may execute the crawling module 130, the text detection module 140, the analysis module 150, and the determination module 160 to implement the comment analysis method in the following steps S310 to S340. In step S310, the crawling module 130 may search for multiple user comments from the network database 200 and store the user comments into the database 120. In step S320, the text detection module 140 may collect at least one of user comments, in which the text detection module 140 includes a font library, and the font library has multiple preset word strings. At least one of the user comments includes at least one of the word strings. In step S330, the analysis module 150 may analyze the at least one of the user comments. In this embodiment, the analysis module 150 may perform natural language analysis (natural language understanding) on user comments.

In step S340, the determination module 160 may determine whether the word strings have constructive significance in the at least one of the user comments according to an analysis result of the at least one of the user comments. Therefore, the comment analysis system 100 of this embodiment may automatically crawl user comments in a network database 200, and may automatically analyze user comments to determine whether user comments have constructive significance. It is worth noting that the constructive significance in a specific embodiment means that user comments include sentences that may reflect specific types of defects for specific products, so that the user of the comment analysis system 100 may understand the defects actually perceived by the end users of a specific product according to the text of the specific defect type, and may improve the defects of specific products. Therefore for users of the comment analysis system 100, the user comments have constructive significance that may improve specific products, and the comment analysis system 100 may perform data statistics on them and generate corresponding prompts. The specific implementation of the above steps S310 to S340 are described in detail in the following embodiments.

FIG. 4 is a flowchart of crawling user comments according to an embodiment of the disclosure. Referring to FIG. 1 and FIG. 4, the crawling module 130 of the processor 110 may execute the following steps S410 to S450. In step S410, the crawling module 130 may obtain link information according to the first schedule. The link information may be, for example, a uniform resource locator (URL) (i.e., a website address). In step S420, the crawling module 130 may store this link information into the database 120. The first schedule is, for example, in units of months, and allows the crawling module 130 to crawl and record the link information corresponding to the user comments on a month-by-month basis. In step S430, the crawling module 130 may select the link information from the database 120 according to the second schedule. In step S440, the crawling module 130 may connect to the network database 200 according to the selected link information, and crawl corresponding multiple user comments in the network database 200. The second schedule is, for example, in units of weeks, and may allow the crawler module 130 to select the previously stored link information on a week-by-week basis to connect to the network database 200 according to the link information, and crawl corresponding multiple user comments stored in the network database 200. In step S450, the crawling module 130 may store the user comments into the database 120.

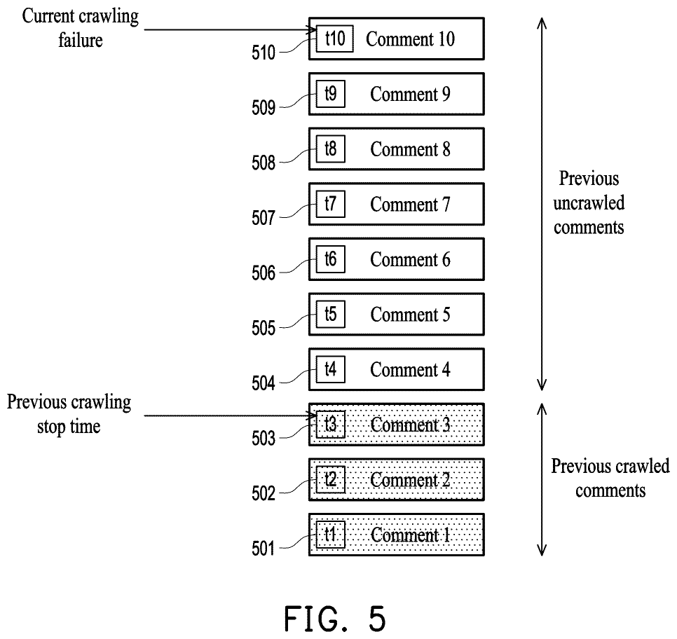

Specifically, referring to FIG. 5, FIG. 5 is a schematic diagram of crawling user comments according to an embodiment of the disclosure. The network database 200 may, for example, record user comments 501 to 510 corresponding to comments 1 to 10 of different comment contents. The user comments 501 to 510 also respectively record the comment times t1 to t10 when the user writes the comment. The comment times t1 to t10 may include, for example, time information of year, month, day, hour, minute, and second. The comment time t10 is later than the comment time t9, the comment time t9 is later than the comment time t8, and so on. In this regard, the crawling module 130 may, for example, first obtain the link information of user comments 501 to 510 according to the first schedule (for example, month by month), and store the link information of the user comments 501 to 510 into the database 120. Then, the crawling module 130 may select the link information from the database 120 according to a second schedule (e.g., week by week), and crawl the user comments in the network database 200 according to the link information. As shown in FIG. 5, in the previous crawling operation (e.g., the previous week), the crawling module 130 may crawl the user comments 501 to 503, and record the crawling time of the last user comment of the user comments 501 to 503 (i.e. record the comment time t3 as the stop time of the previous crawl) to identify the starting comment for the next crawl. Then, in this (current) crawling operation (e.g., this week), the crawling module 130 may crawl the user comments 504 to 510, and record the crawling time of the last user comment of user comments 504 to 510 (i.e., record the comment time t10 as the stop time of this crawl), to identify the starting comment for the next crawl.

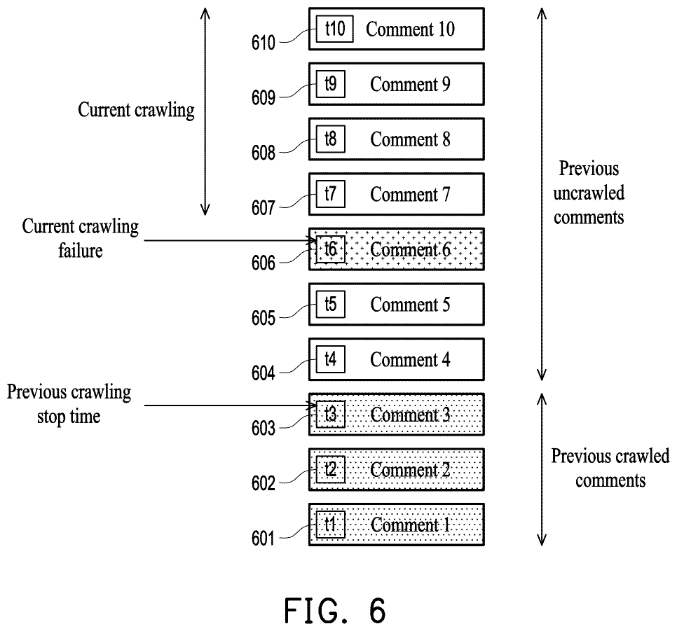

Referring to FIG. 6, FIG. 6 is a schematic diagram of crawling user comments according to another embodiment of the disclosure. The network database 200 may, for example, record user comments 601 to 610 corresponding to comments 1 to 10 of different comment contents. The user comments 601 to 610 also respectively record the comment times t1 to t10 when the user writes the comment. In this regard, the crawling module 130 may, for example, first obtain the link information of user comments 601 to 610 according to the first schedule (for example, month by month), and store the link information of the user comments 601 to 610 into the database 120. Then, the crawling module 130 may select the link information from the database 120 according to a second schedule (e.g., week by week), and crawl the user comments in the network database 200 according to the link information. As shown in FIG. 6, in the previous crawling operation (e.g., the previous week), the crawling module 130 may crawl the user comments 601 to 603, and record the crawling time of the last user comment of the user comments 601 to 603 (i.e. record the comment time t3 as the stop time of the previous crawl) to identify the starting comment for the next crawl. Then, in this (current) crawling operation (e.g., this week), the crawling module 130 may crawl the user comments 604 to 610. However, as shown in FIG. 6, a crawling failure may occur for the user comment 606, and the crawling module 130 will crawl the user comments 604 to 610 again in the next schedule. In one embodiment, if the number of crawling failure attempts of the same link information exceeds the preset number, the crawling module 130 removes the link information from the database 120.

In addition, the reasons for a crawling failure may be, for example, that the page cannot be loaded, product information cannot be loaded, comments cannot be sorted by time, the comments that failed to be collected are greater than or equal to the threshold, comments cannot be limited to the current product, no comments appear on the first page of a non-web page, or the web page cannot be switched to the next page, etc., and the disclosure is not limited thereto.

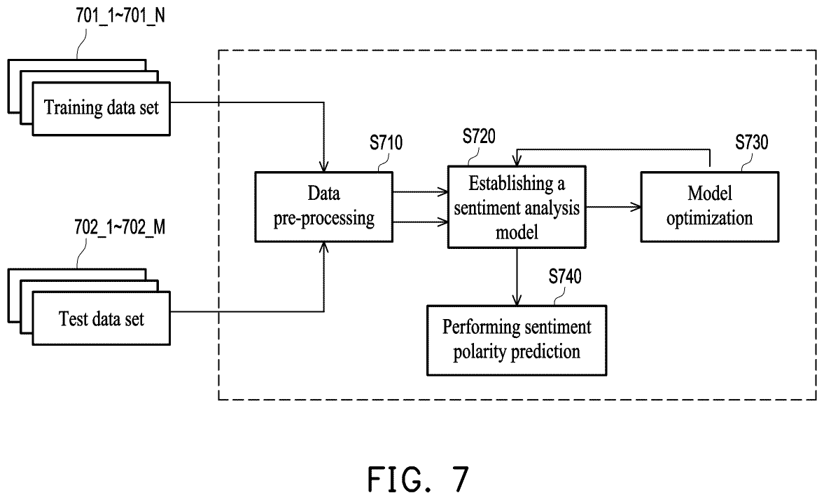

FIG. 7 is a schematic diagram of establishing a sentiment analysis model according to an embodiment of the disclosure. Referring to FIG. 1, FIG. 2, and FIG. 7, in this embodiment, the analysis module 150 may include a sentiment analysis model. The comment analysis system 100 may execute the following steps S710 to S740 to establish and test the sentiment analysis model. In the model training and establishing phase, in step S710, the processor 110 may perform data pre-processing on the training data sets 701_1 to 701_N, where N is a positive integer. In this regard, the processor 110 may first label the comment information in the training data sets 701_1 to 701_N with positive sentiments and negative sentiments. Positive sentiments represent the positive sentimental feelings of the user about a specific product. Negative sentiments represent the negative sentimental feelings of the user about a specific product. Then, the processor 110 may first perform pre-processing operations such as data cleaning, feature processing, and data conversion on the labeled training data set to eliminate text noise interference before model establishment. This may help simplify the complexity of model establishment and speed up its convergence rate. In step S720, the processor 110 may establish a sentiment analysis model using a Bayesian classifier algorithm according to the pre-processed and labeled training data set. In step S730, the processor 110 may perform model optimization on the sentiment analysis model. The processor 110 may perform performance evaluation and correction optimization on the sentiment analysis model until the model performance of the sentiment analysis model converges to a reliable accuracy.

Next, in the model prediction stage, in step S710, the processor 110 may perform data pre-processing on the test data sets 702_1 to 702_M, where M is a positive integer. The processor 110 may perform pre-processing operations such as data cleaning, feature processing, and data conversion on the test data set. In step S720, the processor 110 may input the pre-processed data into the sentiment analysis model. In step S740, the sentiment analysis model may perform sentiment polarity prediction.

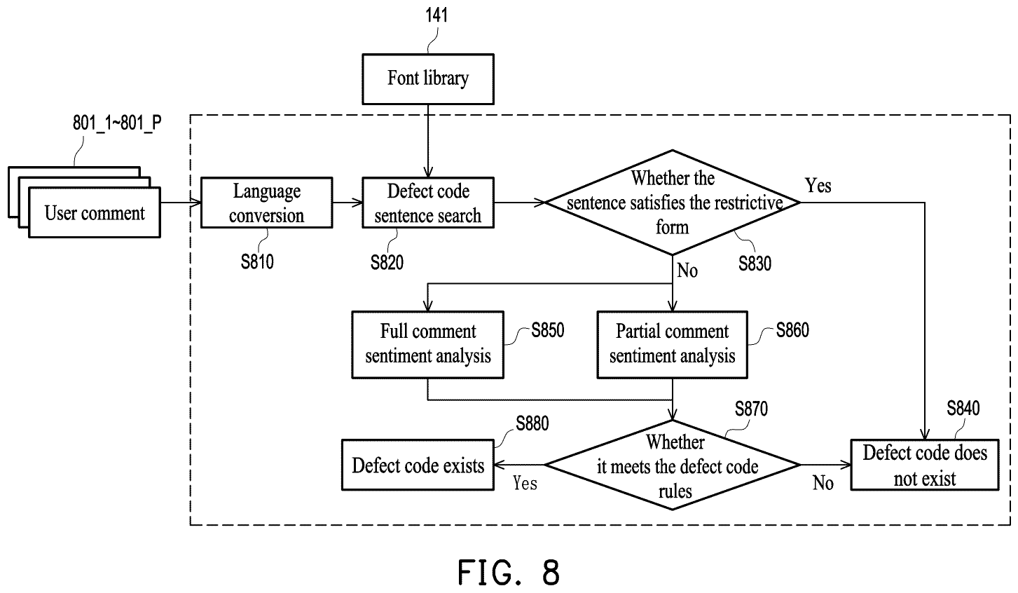

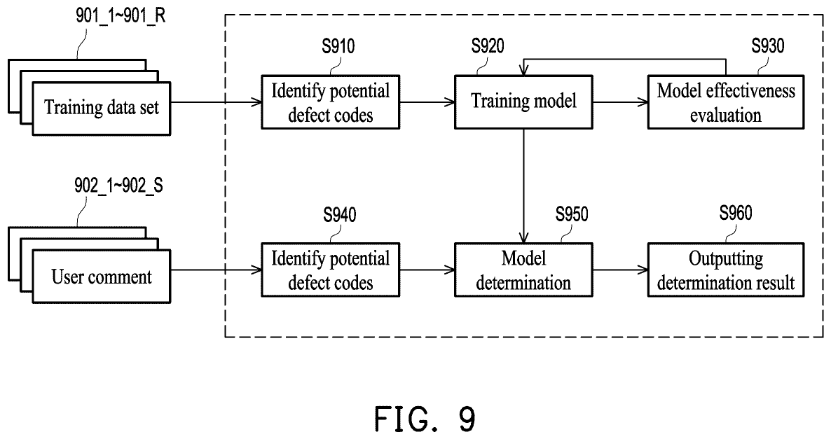

FIG. 8 is a flowchart of a comment analysis method according to an embodiment of the disclosure. Referring to FIG. 1, FIG. 2, and FIG. 8, in this embodiment, the processor 110 may execute the crawling module 130, the text detection module 140, the analysis module 150, and the determination module 160 to implement the comment analysis method in the following steps S810 to S880. In this embodiment, the text detection module 140 includes a font library 141. The font library 141 has multiple preset word strings, and the word strings are, for example, but not limited to multiple defective code sentences. The defective code sentences may include, for example, flickering, dead pixels, bright spots, blurred screens, and/or color aberration, and the disclosure is not limited thereto.

In this embodiment, the processor 110 may execute the crawling module 130 to crawl multiple user comments 801_1 to 801_P, where P is a positive integer. In step S810, the processor 110 may execute the text detection module 140 to perform language conversion on the user comments 801_1 to 801_P. For example, the text detection module 140 may convert the user comments 801_1 to 801_P from Simplified Chinese to Traditional Chinese or English, or the processor 110 may convert the user comments 801_1 to 801_P from Traditional Chinese to Simplified Chinese, etc., and this disclosure is not limited thereto. In step S820, the text detection module 140 may search for defective code sentences in the language-converted user comments 801_1 to 801_P according to the defective code sentences stored in the font library 141.

Next, in step S830, the text detection module 140 may determine whether the defective code sentence satisfies the restrictive form rule of thumb. The text detection module 140 may determine whether the language-converted user comment with a defective code sentence satisfies the restrictive form, so as to determine whether to perform sentiment analysis on the language-converted user comment with a defective code sentence. For example, the restrictive form rule of thumb may be implemented as shown in Table 1 below.

TABLE 1

| Rule | |
|---|---|
| number | Restrictive form rule of thumb |
| 1 | (No, not found, not appeared, not the kind, not, none, |
| | don't, do not, not discovered, not much, will not, |
| | appearance, without any, not a bit, will not, not a |
| | single) + (defective code) |
| 2 | A major highlight, the highlight is, one highlight, there |
| | is no issue whatsoever |
| 3 | No issues + whatsoever + (defective code), no + issues + |
| | (defective code), no (defective code) |
| 4 | (Defective code) + none, (defective code) + is pretty |
| | good too |
| 5 | Fluid lines, elegant lines, outline lines |

In this regard, if the text detection module 140 determines that the defective code sentence satisfies the restrictive form rule of thumb, the processor 110 executes step S840 to determine that a defective code does not exist in the current user comment. On the contrary, if the text detection module 140 determines that the defective code sentence does not satisfy the restrictive form rule of thumb, the processor 110 executes step S850 and step S860. In step S850, the processor 110 may execute the analysis module 150, such as the sentiment analysis module described in the embodiment of FIG. 7, to perform a full comment sentiment analysis on defective code sentences that do not satisfy the restrictive form rule of thumb. Moreover, in step S860, the processor 110 may execute the analysis module 150, such as the sentiment analysis module described in the embodiment of FIG. 7, to perform a partial comment sentiment analysis on defective code sentences that do not satisfy the restrictive form rule of thumb. The partial comment sentiment analysis may be, for example, sentiment analysis performed on the defective code sentence and a sentence before and after it.

For example, a user comment could be “I must give the merchant a big thumbs up for their service. The TV that was delivered to me for the first time had a flickering screen. So I immediately reported it to the customer service. Since it happened during the Chinese New Year, they were on holiday, so they helped arrange the exchange as soon as the new year started. I would also like to thank Skyworth for its excellent after-sales service. It has been almost a month since I received the TV. It is high-definition and the color is correct. I'm very satisfied”. The text detection module 140 may compare the word strings in the font library 141 to determine that the above-mentioned user comment has a defective code sentence “The TV that was delivered to for the first time had a flickering screen.” The analysis module 150 may perform partial comment sentiment analysis on the defective code sentence and the sentences before and after it are “I must give the merchant a big thumbs up for their service. The TV that was delivered to me for the first time had a flickering screen. So I immediately reported it to the customer service”.

In step S870, the processor 110 may execute the determination module 160 to determine whether the user comment meets the defective code rules. In this regard, the determination module 160 may determine whether the defective code rules are met based on the full comment sentiment analysis results and the partial comment sentiment analysis results. For example, the determination module 160 may perform advanced verification of defective codes based on the user star rating and sentiment analysis results. In this regard, the determination module 160 may, for example, perform verification based on the defective code rules of the advanced verification rule of thumb summarized in Table 2 below. If the output result of the determination module 160 is “there is a defective code”, the determination module 160 may execute step S880 to determine that a defective code exists in the current user comment. If the output result of the determination module 160 is “there are no defective code”, the determination module 160 may execute step S840 to determine that a defective code does not exist in the current user comment.

TABLE 2

| Star | Full comment | Partial comment | |
|---|---|---|---|
| rating | sentiment analysis | sentiment analysis | Output result |
| >3 | Positive | Negative | There is a |
| | | | defective code |
| ≤3 | Negative | None | There is a |
| | | | defective code |
| <3 | Negative | Positive | There is a |
| | | | defective code |
| ≤3 | Positive | None | There is a |
| | | | defective code |
| >3 | Positive | Positive | There are no |
| | | | defective code |
| >3 | Negative | Negative | There are no |
| | | | defective code |

FIG. 9 is a schematic diagram of establishing a model and a comment analysis method according to an embodiment of the disclosure. Referring to FIG. 1, FIG. 2, and FIG. 9, in this embodiment, the analysis module 150 may include a trained model. The comment analysis system 100 may perform the following steps S910 to S930 to train the model. The model may be, for example, a neural network (NN) model, an artificial intelligence (AI) model, or a chat generative pre-trained transformer (ChatGPT), etc., and the disclosure is not limited thereto. In this embodiment, in step S910, the processor 110 may process each training data in the training data sets 901_1 to 901_R, where R is a positive integer, to identify the potential defective codes therein. In step S920, the processor 110 may use training data sets that have identified defective codes to train the model, so that the model may identify sentences in the comments and determine whether defective code sentences exist. In step S930, the processor 110 may perform model effectiveness evaluation of the trained model. For example, the model is optimized through iterative computation according to accuracy rate or relevant validation indicators.

In this embodiment, the processor 110 may execute the crawling module 130, the text detection module 140, the analysis module 150, and the determination module 160 to implement the comment analysis method in the following steps S940 to S960. The crawling module 130 may search for multiple user comments 902_1 to 902_S from the network database 200, where S is a positive integer. In step S940, the text detection module 140 may identify potential defective codes for the user comments 902_1 to 902_S to generate a capture frame word string. In step S950, the analysis module 150 may perform model determination through the aforementioned trained model to determine whether the capture frame word string is a real defective code sentence. In step S960, the determination module 160 may output a determination result according to the above analysis result.

Specifically, the text detection module 140 may detect the user comments 902_1 to 902_S according to the defective code detection table in Table 3 below to identify multiple capture frame word strings. The defective code detection table includes defective code sentences, importance order, and synonyms. The text detection module 140 may determine whether defective code sentences or synonyms thereof exist in the user comments 902_1 to 902_S, and identify the capture frame word strings according to the importance order. The analysis module 150 may analyze the capture frame word string to determine whether the capture frame word string is a real defective code sentence, and the determination module 160 may output a determination result according to the analysis result.

TABLE 3

| defective code | Importance | |
|---|---|---|
| sentence | order | Synonyms |
| Broken screen | 1 | “Scraps”, “broken screen”, “shattered”, |
| | | “cracked”, “cracked screen”, “crack”, |
| | | “broken”, “exploded screen” |
| Black screen | 1 | “Black screen”, “screen does not light |
| | | up”, “screen cannot be seen”, “screen not |
| | | lighting up” |
| Black spots | 2 | “Black spots” |
| Dark spots | 2 | “Dark spots” |
| Bright spots | 2 | “Bright spot”, “bad spot”, “green spot”, |
| | | “blue spot”, “red spot” |
| Abnormal | 1 | “Gray screen”, “there is a problem with |
| image | | the screen”, “bad screen”, “Blurry |
| | | screen”, “snowflakes”, “whitened”, |
| | | “screen is dark”, “Color.{,5} is |
| | | abnormal” |
| Flashing | 1 | “Flashing screen”, “flashing”, “Screen |
| screen | | flash”, “Screen.{,5} will.{,5} flash |
| mura | 3 | “mura”,” “boundary line”, “color |
| | | difference” |
| Scratched | 4 | “Scratched”, “scratched line”, “scratched |
| | | line”, “scratched”, “scraped” |
| Bad line | 1 | “Black line”, “line”, “stripe”, “bright |
| | | line”, “dark line” |
| Leakage | 1 | “leak”, “leakage” |
| Smear | 1 | “Smear” |
| Light leak | 3 | “Light leak” |

In addition, the text detection module 140 may detect multiple user comments in the following Table 4 to identify the capture frame word strings, and the analysis module 150 may determine whether the capture frame word string is a real defective code sentence according to the aforementioned trained model, so that the determination module 160 may output the determination result according to the analysis result. As shown in Table 4 below, the analysis module 150 may accurately determine that the fifth user comment has a real defective code sentence according to the aforementioned trained model.

TABLE 4

| User comment | Capture frame word string | Analysis result |
|---|---|---|
| The monitor is huge, so you need to bear | so you need to bear with the | There are no real |
| with the host. There are no dead pixels, | host. No {defect}, | defective code |
| and the 4k144hz properties are indeed very | 4k144hz properties | sentences |
| strong, but it would be better if the price | | |
| was more favorable. Overall, it is | | |
| improved compared to 2k. But the | | |
| perception is not very strong. | | |
| This is a favorable review, I checked the | display x and there are no | There are no real |
| screen with display x and there are no bad | {defect}, the size is very | defective code |
| pixels, the size is very suitable for playing | suitable | sentences |
| games, watching movies, PS5, etc. The | | |
| cable management hole of the shelf was | | |
| broken, so the after-sales service replaced | | |
| it with a bracket, now it's set up and the | | |
| service is pretty good. | | |
| Size: just right for home-use. The screen | just right for home-use. | There are no real |
| has no bright spots/broken, and the display | The screen has no | defective code |
| effect is okay, but I feel that the button | {defect}/broken, and the | sentences |
| design is not very reasonable and it is | display effect | |
| inconvenient to adjust. In addition, the | | |
| built-in sound effects are average. | | |
| The color is very comfortable, the default | not high, it is very good, and | There are no real |
| color is very comfortable, the graininess is | there is no light leakage, | defective code |
| not high, it is very good, and there is no | bright {defect} | sentences |
| light leakage, bright/dead pixels. | | |
| I bought two units, and one of them has a | two units, and one of them | There is a real |
| blurred screen. The quality is average | {defect}. The quality | defective code |
| and the price is cheap. It's my first time to | | sentence |
| buy a product with quality issues. I'm so | | |
| lucky. | | |
| How about it? Isn't it great? The size is | desk very well. There is | There are no real |
| just right and fits my desk very well. | no {defect} and the | defective code |
| There is no color difference and the | resolution is high. | sentences |
| resolution is high. It's not too big or too | | |
| small for playing games. I have fun | | |
| playing on my new computer. The main | | |
| reason is that the price is moderate, and | | |
| very cost-effective. | | |

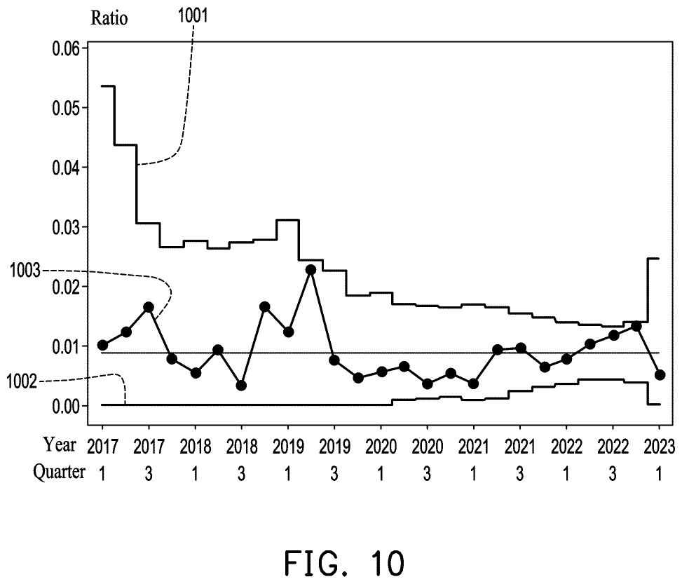

FIG. 10 is a schematic diagram of a statistical control graph according to an embodiment of the disclosure. Referring to FIG. 1, FIG. 2, and FIG. 10, in this embodiment, the determination module 160 may output a determination result according to the above analysis results, and may count multiple user comments corresponding to a specific defective code to generate a statistical control graph as shown in FIG. 10. The statistical control graph of FIG. 10 includes an upper control boundary 1001, a lower control boundary 1002, and a trend line 1003. As shown in FIG. 10, the trend line 1003 is configured to represent the ratio of a specific product corresponding to a specific defect type, the trend line 1003 may change with the statistical results of different years and quarters, and the upper control boundary 1001 and the lower control boundary 1002 also dynamically change according to the trend.

In this embodiment, the comment analysis system 100 may draw a statistical control graph as shown in FIG. 10 according to the total proportion of negative comments caused by specific defects of a specific item and the time sequence of such comments, and automatically monitor whether any data point exceeds the control line (i.e., the upper control boundary 1001 and the lower control boundary 1002). In this regard, when the trend line 1003 exceeds the upper control boundary 1001 in the statistical control graph, or is lower than the lower control boundary 1002 in the statistical control graph, the determination module 160 generates a prompt signal, which can, for example, automatically alert product manufacturers or product sellers about abnormal trends in specific defects in products.

In addition, in one embodiment, the comment analysis system 100 may also provide a conditional query function. For example, product manufacturers or product sellers may connect to the relevant query interface of the comment analysis system 100 and enter keywords with any number of conditions, such as network platform name, product type, comment star rating, defective code, etc., so that the comment analysis system 100 may query all user comment information that meets the conditions according to the keyword comparison mechanism, and may effectively manage business related to product manufacturing or product sales.

To sum up, the comment analysis system and the comment analysis method of the disclosure may automatically crawl user comments in a network database, and may perform natural language analysis on user comments. The comment analysis system and comment analysis method of the disclosure may perform sentiment analysis and/or model prediction on the results of natural language analysis to effectively identify whether user comments have defective code sentences. The comment analysis system and comment analysis method of the disclosure may further continuously count the number of defective codes over time and generate a statistical control graph, so that corresponding prompt information may be automatically generated according to the statistical control graph.

Finally, it should be noted that the foregoing embodiments are only used to illustrate the technical solutions of the disclosure, but not to limit the disclosure; although the disclosure has been described in detail with reference to the foregoing embodiments, persons of ordinary skill in the art should understand that the technical solutions described in the foregoing embodiments may still be modified, or parts or all of the technical features thereof may be equivalently replaced; however, these modifications or substitutions do not deviate the essence of the corresponding technical solutions from the scope of the technical solutions of the embodiments of the disclosure.

What is claimed is:

1. A comment analysis system, comprising:
a crawling module, coupled to a network database and configured to search for a plurality of user comments from the network database and store the user comments into a database;
a text detection module, coupled to the crawling module and comprising a font library, wherein the font library has a plurality of preset word strings, the text detection module is configured to collect at least one of the user comments that comprises at least one of the word strings;
an analysis module, coupled to the text detection module and configured to analyze the at least one of the user comments; and
a determination module, coupled to the analysis module and configured to determine whether the word strings have constructive significance in the at least one of the user comments according to an analysis result of the at least one of the user comments.

2. The comment analysis system according to claim 1, wherein the crawling module obtains link information according to a first schedule, and the crawling module stores the link information into the database,
wherein the crawling module selects the link information according to a second schedule, the crawling module crawls the user comments according to the link information, and the crawling module stores the user comments into the database.

3. The comment analysis system according to claim 1, wherein the crawling module crawls the user comments, and records crawling time of a last user comment of the user comments to identify a starting comment for a next crawl.

4. The comment analysis system according to claim 1, wherein the word strings are a plurality of defective code sentences.

5. The comment analysis system according to claim 4, wherein the text detection module performs language conversion on the user comments, and searches for at least one of the language-converted user comments having at least one of the defective code sentences according to the defective code sentences.

6. The comment analysis system according to claim 5, wherein the text detection module determines whether the at least one of the language-converted user comments having at least one of the defective code sentences satisfies a restrictive form, so as to determine whether to perform sentiment analysis.

7. The comment analysis system according to claim 1, wherein the analysis module performs a full comment sentiment analysis and a partial comment sentiment analysis on the at least one of the user comments, and the determination module determines whether a defective code rule is met according to a full comment sentiment analysis result and a partial comment sentiment analysis result.

8. The comment analysis system according to claim 1, wherein the text detection module detects the user comments according to a defective code detection table to identify a plurality of capture frame word strings,
and the analysis module analyzes the capture frame word strings, the detection module generates a determination result according to an analysis result.

9. The comment analysis system according to claim 1, wherein the user comments correspond to a specific defective code, and the determination module generates a statistical control graph according to the user comments corresponding to the specific defective code.

10. The comment analysis system according to claim 9, wherein in response to a trend line in the statistical control graph exceeding an upper control boundary in the statistical control graph, or being lower than a lower control boundary in the statistical control graph, the determination module generates a prompt signal.

11. A comment analysis method, comprising:
searching for a plurality of user comments from a network database and storing the user comments into a database through a crawling module;
collecting at least one of the user comments through a text detection module, wherein the text detection module comprises a font library, and the font library has a plurality of preset word strings, the at least one of the user comments comprises at least one of the word strings;
analyzing the at least one of the user comments through a sentiment analysis module; and
determining whether the word strings have constructive significance in the at least one of the user comments through a determination module according to an analysis result of the at least one of the user comments.

12. The comment analysis method according to claim 11, wherein storing the user comments into the database comprises:
obtaining link information according to a first schedule through the crawling module;
storing the link information into the database through the crawling module;
selecting the link information according to a second schedule through the crawling module;
crawling the user comments according to the link information through the crawling module;
storing the user comments into the database through the crawling module.

13. The comment analysis method according to claim 11, wherein storing the user comments into the database comprises:
crawling the user comments, and recording crawling time of a last user comment of the user comments through the crawling module to identify a starting comment for a next crawl.

14. The comment analysis method according to claim 11, wherein the word strings are a plurality of defective code sentences.

15. The comment analysis method according to claim 14, wherein collecting the at least one of the user comments comprises:
performing language conversion on the user comments through the text detection module; and
searching for at least one of the language-converted user comments having at least one of the defective code sentences according to the defective code sentences through the text detection module.

16. The comment analysis method according to claim 15, wherein collecting the at least one of the user comments comprises:
determining whether the at least one of the language-converted user comments having at least one of the defective code sentences satisfies a restrictive form through the text detection module, so as to determine whether to perform sentiment analysis.

17. The comment analysis method according to claim 11, wherein the analysis module performs a full comment sentiment analysis and a partial comment sentiment analysis on the at least one of the user comments, and determining whether the word strings have constructive significance in the at least one of the user comments comprises:
determining whether a defective code rule is met according to a full comment sentiment analysis result and a partial comment sentiment analysis result through the determination module.

18. The comment analysis method according to claim 11, further comprising:
detecting the user comments according to a defective code detection table to identify a plurality of capture frame word strings through the text detection module, wherein the analysis module analyzes the capture frame word strings,
determining whether the word strings have constructive significance in the at least one of the user comments comprises:
analyzing the capture frame word strings through the analysis module, wherein the detection module generates a determination result according to an analysis result.

19. The comment analysis method according to claim 11, wherein the user comments correspond to a specific defective code, and the comment analysis method further comprises:
generating a statistical control graph according to the user comments corresponding to the specific defective code through the determination module.

20. The comment analysis method according to claim 19, wherein the comment analysis method further comprises:
in response to a trend line in the statistical control graph exceeding an upper control boundary in the statistical control graph, or being lower than a lower control boundary in the statistical control graph, generating a prompt signal through the determination module.
